(19) United States
(12) Patent Application Publication
(10) Pub. No.: US 2003/0158063 A1
(43) Pub. Date: Aug. 21, 2003

(54) Process and product for application for preserving metallic products from corrosion

(76) Inventor: Robert E. Whitman, Toledo, OH (US)

Correspondence Address: George R. Royer, Suite 416, 316 N. Michigan Street, Toledo, OH, 43624, US

(21) Appl. No.: 10/078,853

(22) Filed: Feb. 20, 2002

(51) Int. Cl. C23G 1/02; C11D 1/00

(52) U.S. Cl. 510/202; 134/3; 134/2; 134/26; 134/28; 134/41; 510/203; 510/209

(57) ABSTRACT

The subject invention is a process for preserving metallic products from deterioration from corrosion or oxidation, comprising the application of a protective product including the following steps of applying,

(a) cleaning the exterior of the metallic product of removing scaling or other externally disposed by products of corrosion;

(b) applying a corrosive removal substance comprised of water, ammonium components, alcohol and a solvent premix which is in turn comprised of alcohol and mineral spirits.

The subject process may include the further process of painting the surface of the metallic surface after the above described anti-corrosive substance is applied and in some cases removed.

### D. DISCUSSION OF PRIOR ART AND BACKGROUND OF THE INVENTION

The invention which is the subject of this patent application is directed to a process for protection of the exterior of a metallic product from corrosion, such as oxidation resulting in rusting of the metallic surface or exterior.

The general area of focus is directed to means to cover the exterior of the product from oxidation or other chemical reactions that cause the surface to be corroded. Another focus of the subject invention is to remove rust, or other corrosive by-products from the exterior surface of a metal.

In short the subject process herein described is adapted to both protect and shield a metallic surface from corrosive activity, as well as clean and remove from the metal surface already existing corrosive substances. The latter cleanser process may be utilized to precede painting on the metallic surface as an additional protective layer;

In the perspective and context of the subject invention, as is known, metallic surfaces are invariably subject to and susceptible to corrosive processes, in which the metallic surfaces reacts chemically with the surrounding elements, most usually oxygen. These reactions result in differing chemical reactions and thus varying chemical processes, generally referred to as corrosive reactions leaving a layer of corrosive material on the outer surface of the metal. One of the most frequently encountered corrosive processes is oxidation of iron resulting in a layer of iron oxide, commonly referred to as rust.

These described corrosive processes leave the metallic surface susceptible to deterioration and if left long enough causes deeper penetration of the corrosion into the metallic object, causing an eventual weakening and deterioration of the entire metallic object. This may adversely affect other interconnected systems or structures. For example, if one portion of an iron-based bridge structure become substantially weakened the entire bridge integrity and strength is adversely affected. Thus, rust protection and rust proofing of all integrated metallic sub-structures of a bridge is one of the most important aspects of maintaining the bridge.

There have been innumerable processes and products concerned and used since the advent of man's use of metallic substances for protection against corrosion. Some of these products have been directed to the simple process of removing a rust or corrosion covered surface, while others have been addressed to solely a protective function. Other products have evolved that are directed to both functions, with some employing expensive chemical or other processes and products. A number of these products have been found to be cumbersome in use, while others have not been effective as a means for quick and effective removal of such existing rust or corrosive coverings.

The subject invention is conceived as an improvement over the existing products and processes that are used in this general area. Consequently, the subject invention is directed as a specific improvement over the general area of products and processes used in this regard. Accordingly, the following objects of the subject invention are directed accordingly.

### E. OBJECTS OF INVENTION

The following are objects of the subject invention:

It is object of the subject invention to provide an improved process for protection metallic surfaces from corrosion.

It is also an object of the invention to provide means to shield a metallic surface from rust or other corrosive processes.

An additional object of the subject invention is to provide an improved method of shielding a iron based structure from rusting.

A further object of the subject invention is to provide an improved method of removing corrosive products from a metal surface.

Yet another object of the subject invention is to provide an improved product for removing rust and/or corrosion substances from a metal surface.

A further object of the subject invention is to provide an improved method of preparing a metal surface for painting.

Still another object of the subject invention is to provide means to protect a metal surface from deterioration.

Other and further objects of the subject invention can be seen in the following description and claims read in view of the drawings herein.

### F. DESCRIPTION OF GENERAL EMBODIMENT AND SUMMARY OF INVENTION

In the most general form of the embodiment of the subject invention, the process in this case involves the following general steps as an overall basis for implementation of the subject invention.

(a) clearing the rough scales and corrosive substances;

(b) applying a corrosive removal substance comprising generally of water, ammonium components, alcohol and a solvent premix which is comprised of alcohol and mineral spirits;

The subject process may include the further process of painting of the surface of the metallic surface after the above described anti-corrosive substance is applied.

It is to be stated that the above process and above discussed substances can be used on all types of metallic substances and may be applicable to all types of corrosion on any type of metallic surface.

### G. DESCRIPTION OF PREFERRED EMBODIMENT

In describing the preferred embodiment of the subject invention it is to be stressed that the following description is only of one specified embodiment of the invention. In so describing a specified embodiment no limitation on the scope of the subject invention will be construed as a result. Further, in describing the subject invention and the components of the anti-corrosive substance it is to be understood that the individual components, as specifically delineated, may include other compounds or elements that fall within the same general chemical classification for such specific product. If such substitute substances are not specifically described it shall not limit the scope of the invention and the claims herein.

In the most general form of the embodiment of the subject invention, the process in this case involves the following general steps as an overall basis to implementation of the subject invention.

(a) clearing the rough scales and corrosive substances;

(b) applying a corrosive removal substance comprised of water, ammonium components, alcohol, and a solvent premix which is in turn comprised of alcohol and mineral spirits;

More specifically the product which incorporates features of more particularly delineated substances include the following substances in ratios specified,

| | | |
|---|---|---|
| A | Water | 77.00% |
| B | Ammonium molybdate | 00.10% |
| C | Rhodafac RE-610 ™ | 1.91% |
| D | Triton x-100 ™ | 0.48% |
| E | Tetrahydro furfuryl alcohol | 2.31% |
| F | Phosphorus acid | 18.20% |
| | | 100.00% |

In this latter formulation, the water and ammonium hydrate are intermixed until the ammonium hydrate is dissolved, with all remaining specified substances being intermixed while basic water and ammonium are in the process of being mixed.

In an alternate embodiment of the subject invention, the anti corrosive compound includes the ratios listed below:

| | | |
|---|---|---|
| A | Water | 76.50% |
| B | Ammonium molybdate | 00.10% |
| C | Rhodafac RE-610 | 1.91% |
| D | Triton x-100 | 0.48% |
| E | Solvent Premix | 2.81% |
| F | 75% Phosphorus acid | 18.20% |
| | Total | 100.00 |

The solvent premix issued in this latter formulation is:

| | |
|---|---|
| Tetrahydro furfuryl alcohol | 82.2% |
| Odorless mineral spirits | 7.8% |
| Total | 100.00% |

As can bee seen with this latter formulation a solvent premix is used, such solvent premix being comprised of tetrahydro furfuryl alcohol at a ratio of 82.2% and mineral spirits, preferably odorless, at a ratio of 7.8%. As can be seen in this latter embodiment the solvent pre-mix is used in place of tetrahydro furfuryl alcohol.

It is to be noted and stressed that the foregoing ratios can be varied from the exact percentages stated above, with more or less of a specified ingredient than that stated above, so long as the components above are included.

In the most general form of the embodiment of the subject invention, the process in this case involves the following general steps as an overall basis for implementation of the subject invention.

(a) clearing the rough scales and corrosive substances;

(b) applying a corrosive removal substance comprising generally of water, ammonium components, alcohol and a solvent premix which is comprised of alcohol and mineral spirits;

The subject process may include the further process of painting of the surface of the metallic surface after the above described anti-corrosive substance is applied.

It is to be stated that the above process and above discussed substances can be used on all types of metallic substances and may be applicable to all types of corrosion on any type of metallic surface.

1: A PROCESS FOR REMOVING CORROSION OR RUST FROM A METALLIC SURFACE.
(a) applying a corrosive removal substance comprised of the following substances with percentage ratios indicated:

| | | |
|---|---|---|
| A | Water | 77.00% |
| B | Ammonium molybdate | 00.10% |
| C | Rhodafac RE-610 ™ | 1.91% |
| D | Triton x-100 ™ | 0.48% |
| E | Tetrahydro furfurrly alcohol | 2.31% |
| F | Phosphorus acid | 18.20% |
| | Total | 100.00% |

2: A PROCESS FOR REMOVING RUST OR CORROSION FROM A METALLIC SUBSTANCE COMPRISING OF STEPS OF APPLYING THE FOLLOWING COMPOSITION OF SUBSTANCES IN THE FOLLOWING INDICATED RATIOS:

| | | |
|---|---|---|
| A | Water | 76.50% |
| B | Ammonium molybdate | 00.10% |
| C | Rhodafac RE-610 ® | 1.91% |
| D | Triton x-100 ® | 0.48% |
| E | Solvent Premix | 2.81% |
| F | 75% Phosphorus acid | 18.20% |
| | Total | 100.00% |

with a solvent premix being used in this latter formulation including:

| | |
|---|---|
| Tetrahydro furfuryl alcohol | 82.2% |
| Odorless mineral spirits | 7.8% |
| Total | 100.00% |

3: A PROCESS FOR PRESERVING METALLIC PRODUCTS FROM DETERIORATION FROM CORROSION OR OXIDATION, COMPRISING THE APPLICATION OF A PROTECTIVE PRODUCT INCLUDING THE FOLLOWING STEPS:
(a) cleaning the exterior of the metallic product of removing scaling or other externally disposed by products of corrosion;
(b) applying a corrosive removal substance comprised of water, ammonium components, alcohol and a solvent premix which is in turn comprised of alcohol and mineral spirits.
